(19) United States
(12) Patent Application Publication
(10) Pub. No.: US 2026/0235391 A1
(43) Pub. Date: Aug. 13, 2026

(54) MEASURING ARRANGEMENT AND METHOD FOR DETERMINING AN ANGULAR POSITION OF A TARGET THAT IS ROTATABLE ABOUT AN AXIS

(71) Applicant: KOSTAL Automobil Elektrik GmbH & Co. KG, Lüdenscheid (DE)

(72) Inventor: Michael Köster, Reichshof Odenspiel (DE)

(73) Assignee: KOSTAL Automobil Elektrik GmbH & Co. KG, Lüdenscheid (DE)

(21) Appl. No.: 19/645,841

(22) Filed: Apr. 13, 2026

Related U.S. Application Data
(63) Continuation of application No. PCT/EP2024/077673, filed on Oct. 2, 2024.

(30) Foreign Application Priority Data
Oct. 13, 2023 (DE) 102023128056.2

(51) Int. Cl. G01B 7/30; G01D 5/20

(52) U.S. Cl. CPC G01B 7/30; G01D 5/20

(57) ABSTRACT

A measuring arrangement for determining an angular position of a target that is rotatable about an axis is described, having a stationary coil arrangement comprising a transmitter coil and at least two receiver coils, and having a rotatable, electrically conductive target, wherein the transmitter coil is acted on by a transmission current that induces voltage signals in the receiver coils as a function of the angular position of the target. A measurement and evaluation unit is configured to determine the angular position of the target from the amplitudes of the voltage signals. According to the invention, an expected value for the phases of the voltage signals is additionally determined from the phase of the transmission current, and the determined angular position of the target is designated as error-free if the phases of the voltage signals match the expected value within a defined tolerance range.

### CROSS-REFERENCE TO RELATED APPLICATIONS

This application is a continuation of International Application No. PCT/EP2024/077673, published in German, with an international filing date of Oct. 2, 2024, which claims priority to DE 10 2023 128 056.2, filed Oct. 13, 2023, the disclosures of which are hereby incorporated in their entirety by reference herein.

### TECHNICAL FIELD

The present invention relates to a measuring arrangement and a method for determining an angular position of a target that is rotatable about an axis, at the highest Safety Integrity Level (ASIL-D).

### BACKGROUND

Such measuring arrangements are known from the prior art and are used particularly for measurement by steering angle sensors (SASs) in the automotive field. The functionalities of the SASs are generally based on various physical properties. Examples of systems that have presently proven most successful in this field are potentiometer-based systems and systems that operate optically or magnetically, as well as inductive measuring systems, to name a few.

In particular, the latter-mentioned inductive measuring systems have the advantage over magnetic systems that regarding robustness against external influences and in particular against external interference fields, they are able to identify and also handle these factors significantly better.

An SAS that is used as a component in a motor vehicle is always employed in relation to safety in present automotive applications. This is primarily due to the functionality of the SAS, which generally must mechanically map the position of the steering wheel over several turns of the steering wheel in such a way that it is measured and output in an absolute manner, i.e., unambiguously and without errors, over the individual turns.

It is also worth noting that for such a mass-produced component in the automotive and automotive supply industries, the cost aspect is presently second only to functional safety in importance. Especially with high production volumes, material and manufacturing costs must be cost-effectively designed.

Regarding material, the number and size of the individual microelectronic components (particularly, IC units) are particularly important. These components are highly complex nowadays, for which reason there is an ever-increasing need for inexpensive and novel concepts or approaches. In addition, as stated at the outset, these components must also have a particularly high level of safety integrity.

This high level of safety integrity also represents a clear distinguishing feature for present and future products in the automotive industry.

Inductive SASs in the automotive industry must therefore meet appropriate safety standards. Automotive Safety Integrity Levels (ASILs), which involve the classification of an inherent safety risk in an automotive system or element, are defined in ISO 26262. This standard reflects the degree of risk reduction that is necessary to prevent a certain hazard, with ASIL-D representing the highest integrity requirements, and ASIL-A representing the lowest.

Thus, a high self-diagnostic capability of the inductive SAS is necessary to meet these safety standards, in particular ASILs C and D, in order to detect systematic and random errors.

A known technique for meeting these integrity requirements at the highest Safety Integrity Level, ASIL-D, is the use of redundancy. Two or more independent inductive sensors are normally used to make multiple measurements and subsequent determinations for the same parameters in different sensor systems. In the present case, this would be the measurement and determination of an angular position of a rotatable metal target.

From the present perspective, however, incorporation of redundant sensors is undesirable, since it increases the overall cost of the system and requires additional surface area and interface connections on the circuit board level. Incorporation of redundant sensors is also undesirable under a further aspect, since it may increase design complexity of the system, and may also cause additional errors, so-called common cause errors, which result from the redundancy of the coils (in particular, a doubling of the coil systems).

In the known prior art, it has not been possible thus far to meet the above-described challenge of achieving the highest Safety Integrity Level (ASIL-D). This is also apparent from DE 11 2021 002 293 T5, for example.

In the cited document, for example a method is presented in which it is ensured that a system may be classified as safe according to certain criteria. This system refrains from use of an inductive position system. In this system, the angular deviation resulting from the inaccuracies of a switching system is monitored. Thus, only an approach for an inductive position system in a redundant circuit (AFE channel) is disclosed, not for a corresponding check for possible errors in the sensor element itself.

Furthermore, an inductive position sensor for determining the position of a movable element is disclosed in US Publication No. 2011/0101968 A1. This position sensor is made up of two subsystems, each having two transmitting units that are situated in an LC resonant circuit on the movable element, and a receiver coil with an evaluation unit. Thus, this involves a redundant coil system which according to the present prior art represents the common variant for meeting corresponding safety criteria. However, this system has the disadvantages described above (in particular, increased material and acquisition costs).

A further coil architecture that deals with angular determination and an inductive position sensor is disclosed in EP 409 758 A1. This coil arrangement is operated here in an electrically “inverted” manner. That is, EP 409 758 A1 proceeds from two transmitter coils and one coil receiver. As a result of superimposing the two transmitter coils, a phase-shifted signal corresponding to the position of the target is generated in the one receiver. At the same time, however, this also means that all electrical errors in this coil system occur directly as position errors and thus do not correspond to the Safety Integrity Level (ASIL D).

### SUMMARY

Proceeding from the prior art, an object of the present invention is to provide a measuring arrangement and a method that may be implemented without redundant sensor sources and without redundant signal conditioning (analog front-end) for an inductive SAS at the highest Safety Integrity Level (ASIL-D) and using the associated target values of the safety metrics.

The stated object is achieved by a measuring arrangement according to independent claims 1 and 2 and by a method according to claim 7.

In a manner that is known per se, the measuring arrangement according to the present invention is provided for determining an angular position of a target that is rotatable about an axis, having a stationary coil arrangement comprising at least one transmitter coil and at least one first and second receiver coil, and having an electrically conductive target that is rotatable with respect to this coil arrangement, wherein the transmitter coil is acted on by a transmission current, having a defined amplitude, frequency, and phase, that induces first and second voltage signals in the first and second receiver coils that are a function of the angular position of the target with respect to the coil arrangement, and having a measurement and evaluation unit that is configured to detect the voltage signals of the receiver coils and determine the angular position of the target from the amplitudes of the voltage signals.

The measuring arrangement according to the invention differs from the prior art in that the measurement and evaluation unit is further configured to determine, based on the phase of the transmission current, an expected value for the phases of the voltage signals of the receiver coils, and to designate the determined angular position of the target as error-free if the phases of the voltage signals match the expected value within a defined tolerance range.

If the phases of the voltage signals do not match the expected value within a defined tolerance range, an error is present in the coil arrangement and/or the signal conditioning unit. By implication, this also means that the subsequent angular determination of the target must be erroneous.

A measurement and evaluation unit is understood to mean any device that is suitable for determining from one or more measured values a variable, in particular the phase and/or the amplitude, that is characteristic of the angular determination, according to a given method. According to the invention, such a measurement and evaluation unit is made up of a signal conditioning unit, and an evaluation unit in which a processor unit, for example a digital signal processor (DSP) or a microcontroller (μC), is present.

The expected value may be determined using different methods. The expected value may be a global value within the measuring arrangement according to the invention, or a value that is dedicated as characteristic of an assembly and/or a component. The assembly is a combination of various electronic components (for example, the coil arrangement, the signal conditioning unit, the evaluation unit) which generally are mounted on a circuit board (chip). The electronic components in the measuring arrangement according to the invention are preferably formed by transmitter coils or receiver coils, resistors, demodulators, multiplexers or analog-digital converters, etc.

The expected value may also be a value that is averaged over a time interval.

Furthermore, the expected value may be calculated based on a mathematical model or determined by accessing values listed in a table.

The expected value may be additionally determined more accurately via further characteristic parameters, for example the temperature of the measuring arrangement. This additional measurement of the temperature parameter is very important, for example for accurately determining the amplitude, which has a strong dependency on temperature.

According to the present invention, it is also provided that the measurement and evaluation unit specifies a tolerance range for the expected value. The measurement and evaluation unit may be configured in such a way that it defines a tolerance range via an upper and lower limit.

If subsequently during the measurement a lower limit has fallen below or an upper limit is exceeded, and the measured value is outside the tolerance range and represents a non-tolerable deviation, as a result the measured angle signal is designated as erroneous.

The comparison of the variables that are characteristic of the angular determination (such as phase and/or amplitude), which is measured and carried out during operation of a motor vehicle, to a predefined expected value allows ongoing recognition of deviations, and thus errors, within the measuring arrangement according to the present invention.

That is, for the case of a non-tolerable deviation, or if the angle signal is designated as erroneous and has been transferred by the evaluation unit to the receiver control units, the receiver control units that use the angle signal in the motor vehicle can detect this error and respond appropriately.

Instead of the two phases ΦA, ΦB of the voltage signals U.A, U.B, it is possible to use a further parameter for error detection and thus qualification of the assemblies and/or components within the measuring arrangement according to the invention (independent claim 2).

The parameter is the magnitude of a vector U.T, which is formed from the relationship between the two amplitudes |U.A|, |U.B| of the voltage signals U.A, U.B in the complex plane (see FIG. 2).

The two parameters, the phases ΦA, ΦB of the voltage signals U.A, U.B, and the magnitude of the vector U.T may contribute individually or jointly (phase and amplitude) to the error detection within the measuring arrangement according to the present invention.

The relationship for the vector U.T is based on the fact that the length, i.e., the magnitude, of the vector U.T across the measured voltage signals U.A, U.B may be calculated as follows:

$$\vert \underline{U . T} \vert = \sqrt{\vert \underline{U . A} {\vert}^{2} + \vert \underline{U . B} {\vert}^{2}}$$

Since the absolute value of the vector U.T is also independent of the angle of the target T, it can be checked using a predefined expected value EW.T and thus used for a further qualification.

In addition, for a qualification in question, a tolerance range TB.T within which proper functioning of the measuring arrangement can be assumed may be defined for the magnitude of the vector U.T.

Thus, the measurement and evaluation unit according to the invention is also configured overall in such a way that it calculates the magnitude of a vector U.T from the amplitude values |U.A|, |U.B| of the voltage signals U.A, U.B, and designates the determined angular position Φ.T of the target T as error-free if the magnitude of the vector U.T of the voltage signals U.A, U.B matches an expected value EW.T within a defined tolerance range TB.T.

In fact, there is a dependency of the absolute value of the vector U.T on the position of the target (for example, height, tilt, axial offset) and on the temperature. As a result, a tolerance range TB.T may be defined specifically for the magnitude of the vector U.T, within which proper operation of the measuring arrangement according to the present invention and of the angle sensor as a whole is assumed.

In contrast, if the magnitude of the vector U.T is outside the predefined tolerance range TB.T, this means an impermissible deviation in at least one of the voltage signals U.A and U.B, so that in this case the determined angular position of the target Φ.T is to be designated as erroneous. In addition, the magnitude of the vector U.T is referred to as the amplitude |U.T|.

For identification of further errors within the measuring arrangement according to the present invention and its components and/or assemblies, it has also proven particularly advantageous to additionally regard the impedance Z as a further characteristic measured variable for the qualification of possible errors, using the phase or the amplitude, or all three measured variables (phase, amplitude, and impedance) jointly.

In this case, for example the phase Φ.S and the amplitude |I.S|, via the measurement of the transmission current I.S. and also the transmission voltage U.S, may be determined in each case from the relationship with the impedance Z:

$$Z = U / I$$

The relationship for the amplitudes and the phases of the particular current signals and voltage signals is based on the fact that the impedance within the coil arrangement according to the present invention may be determined from the two voltage signals U.A and U.B and the transmission voltage U.S., and vice versa.

For the amplitude of the impedance |Z|, the above formula may also be used to determine the other amplitudes for the transmission current |L.S| as well as for the receiver coils in each case for |U.A| and |U.B|.

The following applies:

$$\underline{\vert Z \vert} = \frac{\vert \underline{U {.}_{A / B}} {\vert}_{U}}{\vert \underline{I . S} {\vert}_{I}}$$

The amplitude of the impedance |Z| may thus be determined from the amplitude |U._{A/B}|_{U} of the receiver coils (which represents the voltage present at the receiver coils) and from the amplitude |I/S|_{I} of the transmission voltage (which represents the current I.S present at the transmitter coil).

The phase ΦZ of the impedance results from the phase difference between the phases of the transmission current Φ.S and the phases ΦA, ΦB of the voltage signals U.A, U.B, and vice versa. The following applies:

$$Φ . Z = {Φ}_{A / B} - Φ . S$$

A possible, but not mandatory, determination of the impedance Z within the coil arrangement according to the present invention may be such that, for example, the voltage signals of the receiver coils U.A and U.B, which are phase-shifted by 90° relative to one another, and the transmission voltage U.S. are considered together. For this purpose, besides the voltage signals U.A and U.B the first multiplexer receives the additional transmission voltage U.S. The voltage signals U.A and U.B and the voltage signal U.S are multiplied together within the first multiplexer. The resulting signals are each amplified and filtered by the demodulators downstream from the first multiplexer for the individual voltage signals, and by means of a second downstream multiplexer are provided to the analog-digital (AD) converter, which generates a digital measuring signal therefrom. Based on this digital measuring signal, the impedance of the transmitter coil may now be determined in the measurement and evaluation unit, which in turn allows conclusions to be drawn regarding eddy currents induced in the target T.

If in a further step the phase and the amplitude of the above-described impedance are now compared to a corresponding expected value EW.Z, it is also possible to check the coil arrangement, and in the present case in particular the transmitter coil, for the absence of errors.

Alternatively, the transmitter coil may be investigated for possible errors by measuring the transmission current I.S. For this purpose, the amplitude |I.S| and also the phase Φ.S of the transmission current are monitored at predefined limits when the transmission voltage U.S is assumed to be constant there. As discussed above, this is because errors in the coil arrangement result in a change in the impedance of the transmitter coil, and thus a change in the transmission current. The transmission current may be measured and thus calculated, for example, via the voltage drop at an ohmic series resistor.

According to a further variant for detecting errors, it is conversely also possible to check the receiver coil in this way. In this case, the receiver coil is appropriately energized and the transmitter coil is either short-circuited or left open. Analogously, in the measurement and evaluation unit it is also possible here to determine the impedance Z of the receiver coil, and to compare the phase Φ.Z and the amplitude |Z| of the impedance Z of the receiver coil A, B to an expected value EW.Z within a defined tolerance range TB.Z in the evaluation unit and make a qualification regarding the absence of errors.

Thus, as a whole the coil arrangement according to the present invention may be investigated for possible deviations, and thus errors, via the phase and/or the amplitudes as well as via the impedance Z.

Lastly, undesirable coupling of electromagnetic interference fields into the coil system, in the range of the frequency of the transmission current, may result in significant angle errors in the angular determination of the target T. In a further embodiment of the present invention, it may therefore be advantageous to also check the measuring arrangement according to the invention for such EMC disturbances or to appropriately identify them. For this purpose, the signal generator is switched off (I.S=0) during a measurement in question, and the amplitudes of the individual voltage signals (U.A and U.B) are checked at an upper limit and subsequently qualified.

Further qualification methods may contribute to detecting errors in the target angle Φ.T, not only in the coil arrangement itself but also in the measurement and evaluation unit corresponding to the coil arrangement. According to the present invention, the measurement and evaluation unit is made up of a signal conditioning unit and a downstream evaluation unit.

The purpose of the signal conditioning unit according to the present invention is to carry out the angular determination of the target T for safety-relevant applications in such a way that the highest Safety Integrity Level, ASIL-D, is achieved with minimal outlay of hardware.

The signal conditioning unit according to the present invention is preferably made up of an analog front-end (AFE) circuit. At least two voltage signals (U.A and U.B) of the receiver coils are provided as input signals to this AFE circuit, and in further steps are then filtered, amplified, demodulated, and digitized using various electrical assemblies and/or components, with the objective of individually determining the phase and the amplitude of the input signals in a downstream evaluation unit. It is also advantageous for the analog signals to be sampled by an analog-digital (AD) converter via a second multiplexer.

That is, according to a further refinement of the present invention it is provided that the electrical components present in the signal conditioning unit are qualified in the evaluation unit as erroneous or as error-free by comparing the amplitude and the phase of the input signals U.A and U.B of the receiver coils in an electrical component to a predefined expected value EW.S or tolerance range TB.S.

An AFE circuit according to the present invention is made up of the following electrical components:

A first multiplexer that switches the voltage signals U.A and U.B that are present, as well as the signals from the transmission level and the signal generator, to the first demodulator and to the second demodulator. A downstream second multiplexer and an AD converter.

Also present in the AFE circuit according to the present invention is a signal generator situated downstream from a transmission level. In one preferred embodiment, the transmitter coil applies an alternating current, having a fundamental wave with a sinusoidal shape, to this transmission level. An embodiment of the transmission level as a voltage source is likewise possible. The signal generator generates the sinusoidal signal U.R via an internal clock generator, using an oscillator. In addition, test signals at the input of the first multiplexer and the control signals U1 and U2, which are advantageously phase-shifted by one-fourth period (90°), are generated and provided for the demodulators. All signals operate with a fixed temporal reference to the internal clock pulse of the oscillator.

As a whole, the challenge now lies in likewise checking the above-described signal conditioning unit (AFE circuit) according to the present invention in such a way that errors in the electrical components and/or connection errors between the individual assemblies and/or components in the AFE circuit may be ruled out.

That is, here as well the electrical components present in the signal conditioning unit may be qualified as erroneous or as error-free when the output voltages of the AFE circuit with respect to the input signal are each checked for amplitude and phase in the electrical components.

In this regard, according to the present invention the individual electrical components are to be investigated or qualified in the signal conditioning unit (AFE circuit).

This type of qualification of the signal conditioning unit may be such, for example, that the entire electrical system in the AFE circuit is measured with addition of an expected value, and subsequently compared and thus checked in the evaluation unit.

According to one advantageous embodiment, for this purpose the input of at least one demodulator may be separated from the coil system via the first multiplexer, and in a further step switched to different expected values and thus checked.

For this purpose, the digital output signal of the AD converter is advantageously provided to the evaluation unit to appropriately calculate and check the phase and the amplitude.

In one preferred embodiment of the present invention, the individual electrical components, such as the two multiplexers, the two demodulators, and the AD converter, are thus qualified via a test signal U.G in the overall electrical system in the AFE circuit.

For example, a periodic test signal U.G having a frequency f.0 is switched to at least one of the demodulators, and the phase and the amplitude of U.A and U.B at an expected value are checked or qualified in the evaluation unit.

It is advantageous to check the test signal U.G using different phases (0°-360°) and/or different amplitudes in the evaluation unit. In this way, errors in the overall signal path from the first multiplexer to the AD converter of the AFE circuit, and preferably here in a demodulator due to a change that is checked at an expected value, are detected. Errors in the signal generator and the signal path U1, U2 are thus also reliably identified, since they have a direct influence on the output signal to be checked. In addition, by use of the measuring arrangement according to the invention it is thus also possible to detect critical linearity errors of the electrical system. For this purpose, the phase and the amplitude of the digital output signals at the AD converter are determined and checked or qualified in the evaluation unit.

It may also be advantageous to qualify the driver signal U.R of the signal generator directly via the input of a multiplexer. Similarly, as described above, the periodic signal U.R having a frequency f.0 is switched to one of the demodulators, and the phase and the amplitude of U.A and U.B at the expected value are checked or qualified in the evaluation unit.

According to the present invention, it is also possible to qualify the output voltages of the transmitter U.S in an analogous manner. The output voltage of the transmitter U.S is switched to the two demodulators, and the phase and the amplitude of U.A and U.B at an expected value are checked or qualified in the evaluation unit.

Analogously, the transmission current may also be qualified by the output voltage U.S. A resistor is generally present in the transmission branch or in the transmission level itself, which may be used to calculate the current from the resulting voltage drop at the resistor.

In addition, according to the present invention it is provided to qualify the transmitter coil and the two receiver coils using the measurement method described above. For the transmitter coil, the measurement of the transmission level via the signal U.S of the transmission current may be used. To allow the receiver coil to be correspondingly qualified, according to the invention the transmission level is switched to the receiver coil A or B, and in the next step is qualified via the measurement of U.S.

In one preferred embodiment, in addition the digital data transfer from the AD converter to the processor unit may also be correspondingly qualified. For this measurement, the data transfer must be ensured by an alive counter and a cyclic redundancy check (CRC), so that corresponding transfer errors are detected here as well. In addition, the digital data at the output of the AD converter may be falsified by errors in the RAM, register memory, or FIFO memory. These errors are correspondingly detected by the test signal U.G. It would also be advantageous for the CRC counter and the alive counter calculation to not use the above-mentioned memories (RAM, register memory, FIFO memory) in discrete hardware, so that errors may be detected even without the addition of a test signal U.G.

Lastly, it is of course also possible for the evaluation unit in which a specific processor unit is situated to be appropriately qualified. For this purpose, for example a second processor unit may be used which checks the two components in alternation.

According to the present invention, the object is further achieved by a measurement method for determining an angular position Φ.T of a target T that is rotatable about an axis, using the measuring arrangement described in the main claim, which meets the highest Safety Integrity Level, namely, ASIL-D.

For this purpose, the method according to the present invention comprises the following check steps:
a) a first check in which the electrical components in the signal conditioning unit are checked in the evaluation unit for the absence of errors and
b) a second check in which the coil arrangement is checked in the evaluation unit for the absence of errors and
c) a third check in which first a measurement, and then an angular determination, of the target T takes place in the evaluation unit, and the coil arrangement and the signal conditioning unit are checked in the evaluation unit for the absence of errors and
d) in addition, the first and second checks are repeated in the evaluation unit 10 after the angular determination of the target Φ.T.

Alternatively, according to the present invention the particular check steps may be carried out in some other order. However, it must be taken into account that the check steps in which the signal conditioning unit and the coil arrangement are checked for errors always take place in each case before the angular measurement of the target and the subsequent determination, and also afterwards.

By use of this procedure, according to the present invention the situation is prevented that additionally occurring errors are overlooked during the angular measurement of the target and thus remain unconsidered. This also ensures that the highest Safety Integrity Level, ASIL-D, is achieved using this procedure.

Thus, to enable the first check step to be carried out, according to the present invention the individual electrical components in the signal conditioning unit, as described above, are checked for the absence of errors. For this purpose, the phase and the amplitude of the input signals of the components are individually determined in a downstream evaluation unit, compared to an expected value, and subsequently qualified.

The second check step provides that the coil arrangement is checked for the absence of errors. Measurements of the transmission current and the transmission voltage, and the amplitude and phase checks (Φ.A, Φ.B, U.T) correlated therewith, as described above, are carried out in the transmitter coil and/or receiver coil, respectively.

A measurement of the target T is carried out in the third check step. After the measurement, the target angle Φ.T is calculated in the evaluation unit. In addition, the coil arrangement and the signal conditioning unit are checked via the phases Φ.A, Φ.B and via the amplitude U.T.

Thus, by use of the checking method according to the present invention, it is no longer necessary to double the number of receiver circuits to achieve the highest Safety Integrity Level, ASIL-D, via redundancy, since all critical assembly errors and/or component errors may thus be reliably detected.

The checking method according to the present invention is thus independent of the coil design and therefore applies to any given coil arrangement and/or coil system (coil architecture).

The above-described advantages, which have a correlation with the measuring arrangement, likewise result for the method.

### BRIEF DESCRIPTION OF THE DRAWINGS

The present invention is described in greater detail below with reference to the appended drawings, in which:

FIG. 1 shows a simplified illustration of an inductive measuring arrangement;

FIG. 2 shows a complex rotating phasor representation for the voltage signals U.A, U.B, U.T and the current I.S, using the cosine reference system; and

FIG. 3 shows a block diagram of the inductive measuring arrangement together with a detailed design of the signal conditioning unit.

### DETAILED DESCRIPTION

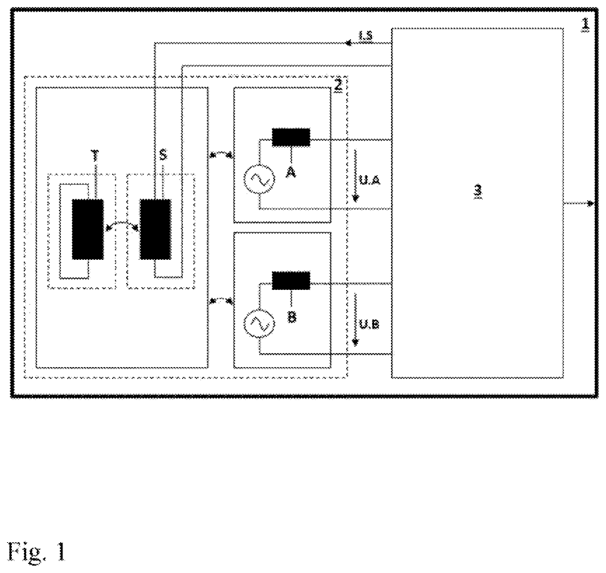

FIG. 1 shows one embodiment of the measuring arrangement 1 according to the present invention. In this measuring arrangement 1, the physical measurement principle of eddy currents and inductive coupling applies for detecting the position of a movable, electrically conductive target T that moves across a coil set.

That is, the coils in coil arrangement 2 are positioned in such a way that the transmitter coil S induces a secondary voltage U.A and U.B, respectively, in the two receiver coils A, B, which is a function of the position of the rotatable, electrically conductive target T across the transmitter coil S.

Thus, by use of the downstream measurement and evaluation unit 3 in the first and second receiver coils A, B, as shown in FIG. 1, the respective amplitude |U.A| and |U.B| and the phase Φ.A and Φ.B of the first and second voltage signals U.A and U.B may be detected, and based on the two amplitudes |U.A| and |U.B| the target angle Φ.T may be calculated using the arctangent function, as described above.

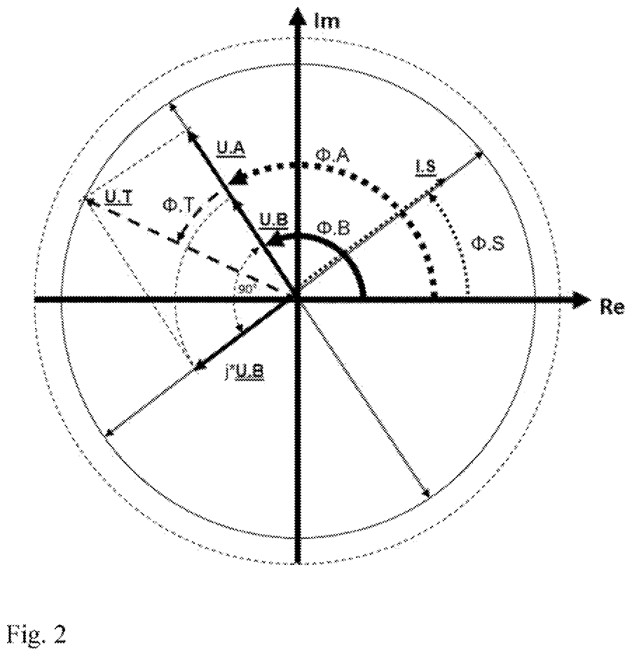

This relationship and the resulting calculation of the relevant parameters, in particular of the angle signal of the target Φ.T, are shown in FIG. 2 in a complex rotating phasor representation.

The phases Φ.A and Φ.B in the complex representation as shown in FIG. 2 are calculated as follows:

$$Φ A = arg ( U . A ) = arc tan 2 ( \frac{Im ( \underline{U . A} )}{Re ( \underline{U . A} )} )$$

$$Φ B = arg ( U . B ) = arc tan 2 ( \frac{Im ( \underline{U . B} )}{Re ( \underline{U . B} )} )$$

During a measurement for a corresponding qualification, the amplitude |I.S|, the phase Φ.S, and the frequency f.S of the transmission current I.S are predefined and regarded as constant.

The input coils A and B, which in FIG. 2 are phase-shifted by 90° with respect to one another, for example, generate signals of the form:

$$u 0 . A ( t ) = U 0. A \cdot cos ( Φ . T ) \cdot sin ( 2 \cdot π \cdot f \cdot t + Φ . A )$$

$$u 0. B ( t ) = U 0. B \cdot sin ( Φ . T ) \cdot cos ( 2 \cdot π \cdot f \cdot t + Φ . B )$$

where Φ.T represents the angle of the rotatable, conductive target T. In the error-free case and under the assumption that

$$U 0. A = U 0 . B = U 0 und Φ . A = Φ . B gilt ,$$

the angle of the rotatable, conductive target Φ.T may be determined in a known manner, and advantageously independently of the amplitude U0 of the input voltage.

In this case the following applies:

$$Φ . T = arctan 2 ( \frac{\vert \underline{U . B} \vert}{\vert \underline{U . A} \vert} )$$

Furthermore, without limitation of generality, in the unloaded case, i.e., under the assumption that the input impedance of signal conditioning unit 4 is much greater than the input impedance of the receiver coil A or B, the following relationship applies:

$$U . A = U 0. A$$

$$U . B = U 0. B$$

$$Φ . A = Φ . B = Φ . 0$$

Another important parameter for identifying possible errors in the measuring arrangement 1 according to the present invention, as illustrated in FIG. 2, is the vector U.T.

It is advantageous to calculate this vector from the combination of the two amplitude values of U0.A and U0.B, where the following applies:

$$\underline{U . T} = U 0. A + j \cdot U 0. B mit j \hat{} 2 = - 1$$

The vector U.T rotates in the complex plane as a function of the target angle Φ.T. In the error-free case and under the assumption that

$$U 0. A = U 0 . B = U 0 and Φ . A = Φ . B = Φ . 0$$

U.T simplifies to:

$$\underline{U . T} = U 0 \cdot ( cos ( Φ . T ) + j sin ( Φ . T ) ) \cdot exp ( j \cdot Φ 0 )$$

$$\underline{U . T} = U 0 \cdot exp ( j \cdot Φ . T + j \cdot Φ 0 )$$

and the following applies as a function of time:

$$u . T ( t ) = Re \{ \underline{U . T} \cdot exp ( 1 \cdot 2 \cdot π \cdot f \cdot t ) \}$$

The vector U.T of the individual receiver coil A, B is thus unambiguously assigned via the angular position of the movable, conductive target T, and may consequently be used for error detection, in particular in coil arrangement 2.

Furthermore, FIG. 2 shows the relationship in a complex rotating phasor representation for the voltage signals and the amplitudes U0.A and U0.B as a function of time, as follows:

$$\underline{U 0. A} = U 0. A \cdot cos ( Φ . T ) \cdot exp ( j \cdot Φ . A ) mit j \hat{} 2 = - 1$$

$$\underline{U 0. B} = U0 . B \cdot sin ( Φ . T ) \cdot exp ( j \cdot Φ . B ) mit j \hat{} 2 = - 1$$

$$where$$

$$U 0. A ( t ) = Re \{ U 0. A \cdot exp ( j \cdot 2 \cdot π \cdot f \cdot t ) \}$$

$$U 0. B ( t ) = Re \{ U 0. B \cdot exp ( j \cdot 2 \cdot π \cdot f \cdot t ) \}$$

Use is made of the relationship that electrical networks may be unambiguously described via the complex notation (real and imaginary parts or via amplitude and phase) of voltage, current, and impedance.

Based on this relationship and the discussion above, the amplitude of the induced voltage is unambiguously assigned to the individual receiver coil via the angular position of the movable, conductive target. In contrast, in the induced voltage of an individual receiver coil the phase is constant over the angular position of the target and may thus be used to detect errors in particular in the coil arrangement.

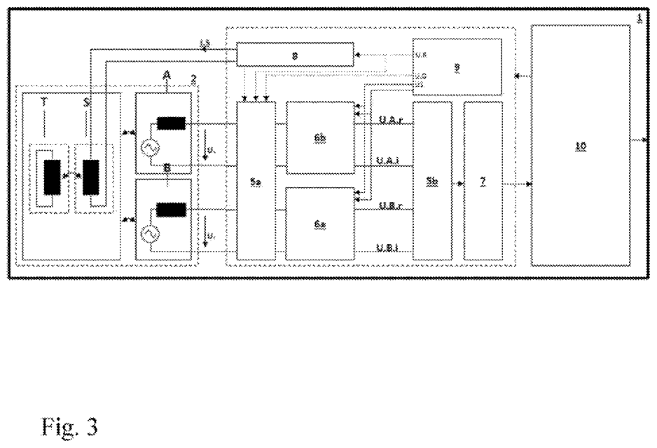

This error detection, which takes place using the various check steps, may subsequently also be carried out in signal conditioning unit 4 or in evaluation unit 10, as illustrated in FIG. 3. In practice, the signal path may be started in the raw signals U.A and U.B, followed by analog processing in a first multiplexer 5a and the downstream demodulators with filters and amplifiers 6a and 6b, which contain the voltage signals U.A.re, U.A. and U.B.re, U.B.im, allocated to a second multiplexer 5b. These voltage signals U.A.re, U.A. and U.B.re, U.B.im are then further provided for digital processing in an AD converter 7, and lastly go to evaluation unit 10, which calculates the exact position of the target T and thus, the target angle Φ.T, containing errors.

Possible errors in the target angle Φ.T in measuring arrangement 1 according to the invention, and analogously also in an inductive angle sensor, in most cases are correlated with errors in coil arrangement 2 (ohmic changes, fracture, or short circuit in the line and/or vias, ohmic and/or capacitive couplings between the coils) and/or in the electronics (measurement and evaluation unit 3) of the inductive angle sensor.

According to the present invention, the errors in these components and/or the assemblies, which may result in a safety-critical erroneous calculation of the target angle Φ.T, may be identified very precisely by measuring arrangement 1 proposed here and the checking method developed for same.

Thus, under any circumstances, it is important to reliably and precisely detect these errors in the overall signal path of an inductive steering angle sensor, so that a measuring arrangement 1 is provided here which accurately recognizes such errors and thus enables the highest Safety Integrity Level, ASIL-D. Further embodiments of measuring arrangement 1 according to the present invention are described below, having a design that likewise meets the highest Safety Integrity Level.

In this case, signal conditioning unit 4 may preferably be situated on an individual assembly (an integrated circuit, or IC for short). This embodiment results not only in significant material and cost savings, but also in meeting all safety-relevant criteria of the highest Safety Integrity Level, ASIL-D.

In a further embodiment, the checking method according to the present invention is valid for implementing not only coil arrangement 2 as illustrated in FIG. 1, but also for any given coil systems (coil architecture). That is, if multiple coil systems are needed to make turn calculations in the steering angle sensor even more accurate, here as well signal conditioning unit 4 may be implemented in only one discrete assembly (IC) without compromising safety. It is necessary only to add another demodulator and a second transmission level.

In consideration of the sampling rate, it is likewise conceivable to dispense with a second demodulator or even a third or fourth demodulator, and for a second, third, or fourth coil system to be qualified according to the invention at the demodulator, via a multiplexer. The sampling rate necessary for these savings generally results from the maximum acceleration and speed of the target T to be measured.

It may also prove advantageous for AD converter 7 and second multiplexer 5b to be situated in evaluation unit 10 and not in signal conditioning unit 4 itself, so that here as well, installation space and thus also costs may be saved.

Furthermore, it is conceivable for the two demodulators 6a, 6b to be implemented in software when AD converter 7 is situated downstream from an amplifier. However, it must be noted that in this case the sampling rate for a possible qualification must be significantly increased.

In addition, it is also possible to replace one of the demodulators 6a or 6b with direct sampling of the voltage signals U.A and U.B in time with the signals U1 and U2 in order to obtain the signals U.A.re, U.A.im, U.B.re, U.B.im for a possible qualification.

As a whole, measuring arrangement 1 according to the present invention and the corresponding checking method have shown that by determining the phase Φ.A, Φ.B and the amplitude |U.A|, |U.B| of the voltage signals U.A, U.B of the two receiver coils A and B, an angular determination Φ.T is made possible that corresponds overall to the highest Safety Integrity Level (ASIL-D), and thereby uses a reduced number of coils, which in the preferred form for processing the signals requires only a single assembly (IC).

As a result, a corresponding expansion to a redundant system is no longer necessary, so that material, installation space (chip surface area), and also the corresponding costs are significantly reduced.

### LIST OF REFERENCE SYMBOLS

1 measuring arrangement
2 coil arrangement
S transmitter coil
A first receiver coil
B second receiver coil
T target
3 measurement and evaluation unit
4 signal conditioning unit
5a first multiplexer
5b second multiplexer
6a first demodulator
6b second demodulator
7 AD converter
8 transmission level
9 signal generator
10 evaluation unit

What is claimed is:

1. A measuring arrangement for determining an angular position of an electrically conductive, rotatable target, the measuring arrangement comprising:
a stationary coil arrangement including a transmitter coil and a first receiver coil and a second receiver coil;
wherein the target is rotatable about an axis with respect to the coil arrangement; and
the transmitter coil is acted on by a transmission current, having a defined amplitude, frequency, and phase, that induces first and second voltage signals in the first and second receiver coils that are a function of an angular position of the target with respect to the coil arrangement;
a measurement and evaluation unit configured to detect the voltage signals of the receiver coils and determine the angular position of the target from amplitudes of the voltage signals; and
the measurement and evaluation unit is further configured to determine, based on the phase of the transmission current, an expected value for phases of the voltage signals of the receiver coils, and to designate the determined angular position of the target as error-free if the phases of the voltage signals of the receiver coils match the expected value for the phases of the voltage signals within a defined tolerance range.

2. A measuring arrangement for determining an angular position of an electrically conductive, rotatable target, the measuring arrangement comprising:
a stationary coil arrangement including a transmitter coil and a first receiver coil and a second receiver coil;
wherein the target is rotatable about an axis with respect to the coil arrangement; and
the transmitter coil is acted on by a transmission current, having a defined amplitude, frequency, and phase, that induces first and second voltage signals in the first and second receiver coils that are a function of an angular position of the target with respect to the coil arrangement;
a measurement and evaluation unit that is configured to detect the voltage signals of the receiver coils and determine the angular position of the target from the amplitudes of the voltage signals; and
the measurement and evaluation unit is further configured to calculate the magnitude of a vector from the amplitude of the voltage signals of the receiver coils, and to designate the determined angular position of the target as error-free if the magnitude of the vector of the voltage signals of the receiver coils matches an expected value within a defined tolerance range.

3. The measuring arrangement according to claim 1, wherein:
the measurement and evaluation unit is further configured to compare and qualify the phase and the amplitude of an impedance of the transmitter coil and/or of at least one of the receiver coils to an expected value within a defined tolerance range.

4. The measuring arrangement according to claim 1 wherein:
the measurement and evaluation unit is formed from a signal conditioning unit and an evaluation unit.

5. The measuring arrangement according to claim 4, wherein:
electrical components present in the signal conditioning unit are qualified in the evaluation unit as erroneous by comparing the amplitude and the phase of the voltage signals of the receiver coils to a predefined expected value or tolerance range.

6. The measuring arrangement according to claim 4 wherein:
the signal conditioning unit is situated on an individual assembly (IC).

7. A method for determining an angular position of an electrically conductive, rotatable target using a measuring arrangement according to claim 4, comprising the steps:
a first check in which the electrical components in the signal conditioning unit are checked in the evaluation unit for the absence of errors;
a second check in which the coil arrangement is checked in the evaluation unit for the absence of errors;
a third check in which first a measurement, and then an angular determination, of the target takes place in the evaluation unit; and
a final check in which the coil arrangement and the signal conditioning unit are checked for the absence of errors; and
wherein the first and second checks are repeated in the evaluation unit after the angular determination of the target.

8. The method according to claim 7, wherein the order of the first, second, and third checks may be interchanged.

9. The method according to claim 7, wherein the first, second, third, and final check may be applied to any given coil arrangement or coil system.

10. The measuring arrangement according to claim 2, wherein:
the measurement and evaluation unit is further configured to compare and qualify the phase and the amplitude of an impedance of the transmitter coil and/or of at least one of the receiver coils to an expected value within a defined tolerance range.

11. The measuring arrangement according to claim 2 wherein:
the measurement and evaluation unit is formed from a signal conditioning unit and an evaluation unit.

12. The measuring arrangement according to claim 11, wherein:
electrical components present in the signal conditioning unit are qualified in the evaluation unit as erroneous by comparing the amplitude and the phase of the voltage signals of the receiver coils to a predefined expected value or tolerance range.

13. The measuring arrangement according to claim 11 wherein:
the signal conditioning unit is situated on an individual assembly (IC).
